(19) United States
(12) Patent Application Publication
(10) Pub. No.: US 2025/0261048 A1
(43) Pub. Date: Aug. 14, 2025

(54) METHOD FOR PROCESSING INFORMATION, AND DEVICE

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN)

(21) Appl. No.: 19/191,999

(22) Filed: Apr. 28, 2025

Related U.S. Application Data
(63) Continuation of application No. PCT/CN2022/129594, filed on Nov. 3, 2022.

(51) Int. Cl. H04W 36/00; H04L 1/1812; H04W 36/02

(52) U.S. Cl. CPC H04W 36/0005; H04L 1/1812; H04W 36/023

(57) ABSTRACT

Provided is a method for processing information. The method is applicable to a terminal, and the method includes: resetting or partially resetting medium access control (MAC) during a layer 1/layer 2-triggered mobility (LTM) process. The terminal includes: a memory and a processor; wherein the memory is configured to store at least one program code, wherein the processor is configured to load and run the at least one program code, to cause the terminal to perform the method.

### CROSS-REFERENCE TO RELATED APPLICATION

This application is a continuation of International Application No. PCT/CN2022/129594, filed Nov. 3, 2022, the entire disclosure of which is incorporated herein by reference.

### TECHNICAL FIELD

The present disclosure relates to the technical field of communications, and in particular, relates to a method and apparatus for processing information, a method and apparatus for transmitting data, and a device and a storage medium thereof.

### RELATED ART

During a cell handover process for a terminal in a connected state, the terminal needs to perform medium access control (MAC) layer reset, radio link control (RLC) layer re-establishment, and Packet Data Convergence Protocol (PDCP) layer re-establishment/data recovery, resulting in a longer delay in protocol stack processing.

For reduction of the delay, layer 1 (L1)/layer 2 (L2)-triggered mobility (LTM) is introduced to limit the handover scenarios. The processing for the protocol layer during the LTM process is currently under discussion.

### SUMMARY

Embodiments of the present disclosure provide a method for processing information, and a device, which provide a processing method for a protocol layer during an LTM process. The technical solutions are as follows:

According to some embodiments of the present disclosure, a method for processing information is provided. The method is applicable to a terminal, and the method includes: resetting or partially resetting MAC during an LTM process.

According to some embodiments of the present disclosure, a terminal is provided. The terminal includes a memory and a processor. The memory stores at least one program code. The processor is configured to load and run the at least one program code, to cause the terminal to perform the method for processing information as described above.

According to some embodiments of the present disclosure, a terminal is provided. The terminal includes a memory and a processor. The memory stores at least one program code. The processor is configured to load and run the at least one program code, to cause the terminal to: transmit uplink data over at least one of a MAC layer or an RLC layer.

### BRIEF DESCRIPTION OF DRAWINGS

For clearer descriptions of the technical solutions according to the embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other drawings from these accompanying drawings without creative efforts.

FIG. 1 is a schematic diagram of a user plane protocol structure according to some embodiments of the present disclosure;

FIG. 2 is a schematic diagram of an inter-base station cell handover process according to some embodiments of the present disclosure;

FIG. 3 is a flowchart of a method for processing information according to some embodiments of the present disclosure;

FIG. 4 is a flowchart of a method for processing information according to some embodiments of the present disclosure;

FIG. 5 is a flowchart of a method for processing information according to some embodiments of the present disclosure;

FIG. 6 is a flowchart of a method for processing information according to some embodiments of the present disclosure;

FIG. 7 is a flowchart of a method for transmitting data according to some embodiments of the present disclosure;

FIG. 8 is a flowchart of a method for transmitting data according to some embodiments of the present disclosure;

FIG. 9 is a flowchart of a method for transmitting data according to some embodiments of the present disclosure;

FIG. 10 is a schematic diagram of an apparatus for processing information according to some embodiments of the present disclosure;

FIG. 11 is a schematic diagram of an apparatus for transmitting data according to some embodiments of the present disclosure; and

FIG. 12 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The user plane involves the protocol stack and related processes for transmitting terminal data. FIG. 1 illustrates a schematic diagram of a user plane protocol structure according to some embodiments of the present disclosure.

In some embodiments, the user plane protocol structure involves: a Service Data Adaptation Protocol (SDAP) layer, a PDCP layer, a MAC layer, an RLC layer, and a physical layer (PHY).

The SDAP layer is responsible for the mapping between quality of service (QOS) flows and data radio bearers (DRBs).

The PDCP layer is responsible for encryption and decryption, integrity protection, header compression, sequence number maintenance, reordering, and in-sequence delivery, and the like. Illustratively, the new radio (NR) PDCP supports out-of-order delivery based on network configuration. Additionally, to improve the reliability of data packet transmission, the NR PDCP also supports functions such as duplicate data transmission.

The RLC layer is responsible for packet segmentation, reassembly, and error detection of RLC service data unit (RLC SDU).

The MAC layer is responsible for the mapping between logical channels and transport channels, multiplexing and demultiplexing, uplink and downlink scheduling related procedures, random access procedures, and the like. Illustratively, NR MAC introduces some new features, such as bandwidth part (BWP) activation/deactivation processes, beam failure recovery processes, and the like.

Illustratively, from the perspective of the user plane data processing flow (using the processing at the transmitter end as an example), user plane data first arrives at the SDAP layer in the form of QoS flows. The SDAP layer is responsible for mapping data from different QoS flows to different DRBs, adding QoS flow identifiers to the data according to network configuration, and generating SDAP packet data units (SDAP PDU) and delivering the SDAP PDU to the PDCP layer.

Subsequently, the PDCP layer performs related processing on the SDAP PDU (i.e., PDCP SDU), including header compression, encryption, integrity protection, and the like, and generates PDCP PDU to be delivered to the RLC layer. The RLC layer processes the RLC SDU according to the configured RLC mode, such as RLC SDU segmentation and retransmission management. The MAC layer is responsible for multiplexing the data of logical channels into a MAC PDU (also referred to as a transport block), which may include multiple RLC SDUs or segments of RLC

SDUs. These RLC SDUs may come from different logical channels or from the same logical channel.

Illustratively, the NR system supports the handover process of a terminal (also referred to as a user equipment (UE)) in a connected state. In a case where a user using network services moves from one cell to another cell, or due to reasons such as adjustment of wireless transmission service load, activation operation maintenance, and equipment failure, to ensure the continuity of communication and the quality of service, the system needs to transfer the communication link between the user and the original cell to the new cell, i.e., the cell handover process needs to be executed.

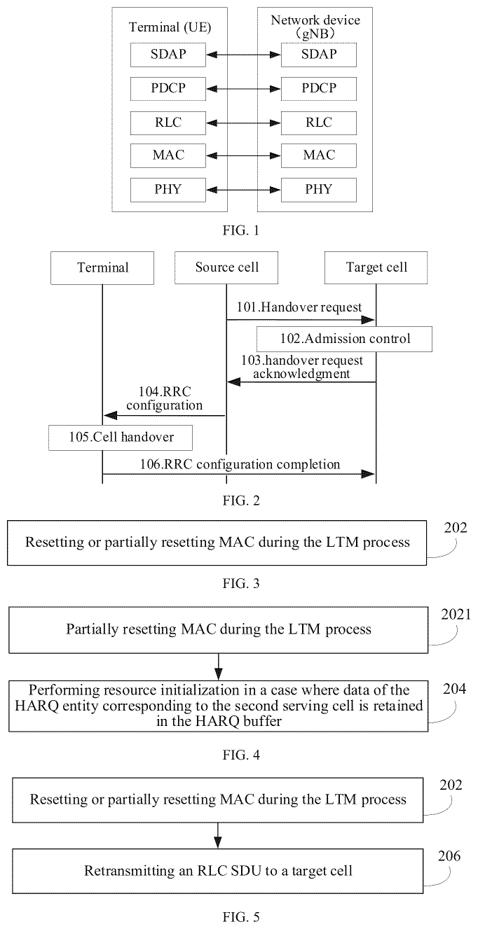

FIG. 2 illustrates a schematic diagram of the inter-base station cell handover process according to some embodiments of the present disclosure. The cell handover process includes the following processes.

In process 101, a source cell transmits a handover request to a target cell.

Illustratively, the source cell is a serving cell where the terminal is located before the cell handover process, and the target cell is a serving cell where the terminal is located after the cell handover process.

In some embodiments, the source cell triggers the handover based on the layer 3 (L3) measurement results reported by the terminal and transmits a handover request (HANDOVER REQUEST) to the target cell over an Xn interface.

In process 102, the target cell performs admission control.

In process 103, the target cell transmits handover request acknowledgment information to the source cell.

In process 104, the source cell transmits radio resource control (RRC) configuration information to the terminal.

In some embodiments, after receipt of the handover request from the source cell, the target cell provides the RRC configuration of the target cell as part of request acknowledgement information (HANDOVER REQUEST ACKNOWLEDGE) for feeding back to the source cell.

Subsequently, the source cell transmits indication information (i.e., RRCReconfiguration) to the terminal, which is used to instruct the terminal to initiate the cell handover process; and the source cell transmits RRC configuration information for accessing the target cell to the terminal. In process 105, the terminal performs cell handover.

In process 106, the terminal transmits RRC configuration completion information to the target cell.

After receipt of the RRC configuration, the terminal performs the cell handover process to access the target cell. Subsequently, the terminal transmits RRC configuration completion information (i.e., RRCReconfigurationComplete) to the target cell.

Illustratively, after receipt of the signaling for the cell handover process, the terminal performs the following processing for each protocol layer:
For handover processes that require updating security information, the terminal performs MAC reset, RLC re-establishment, and PDCP re-establishment. For example, applying new keys, retransmitting unacknowledged PDCP SDUs, or the like.
For handover processes that do not require updating security information, the terminal performs MAC reset, RLC re-establishment, and PDCP data recovery. For example, for an acknowledged mode data radio bearer (AM DRB), PDCP PDUs that need to be retransmitted is redelivered to the lower layer for transmission.

Based on this, during the cell handover process, regardless of whether the key needs to be updated, the terminal needs to perform MAC reset and RLC re-establishment. The specific actions of MAC reset and RLC re-establishment include:

### (1) MAC Reset Process

If a reset of the MAC entity is requested by upper layers, the MAC entity shall:
initialize Bj for each logical channel to zero;
stop (if running) all timers;
consider all timeAlignmentTimers as expired and perform the corresponding actions in clause 5.2;
set the NDIs for all uplink hybrid automatic repeat request (HARQ) processes to the value 0;
set the NDIs for all HARQ process IDs to the value 0 for monitoring physical downlink control channel (PDCCH) in Sidelink resource allocation mode 1;
stop, if any, ongoing Random Access procedure;
discard explicitly signaled contention-free Random Access Resources for 4-step RA type and 2-step RA type, if any;
flush Msg3 buffer;
flush MSGA buffer;
cancel, if any, a triggered Scheduling Request procedure;
cancel, if any, a triggered buffer status report (BSR) procedure;
cancel, if any, a triggered power headroom report (PHR) procedure;
cancel, if any, a triggered consistent listen before talk (LBT) failure;
cancel, if any, a triggered beam failure recovery (BFR);
cancel, if any, a triggered Recommended bit rate query procedure;
cancel, if any, a triggered Configured uplink grant confirmation;
cancel, if any, a triggered Desired Guard Symbol query;
flush the soft buffers for all DL HARQ processes;
for each DL HARQ process, consider the next received transmission for a TB as the very first transmission;
release, if any, a temporary cell-radio network temporary identifier (C-RNTI); and
reset all beam failure indication_COUNTERs (BFI_COUNTERs).

### (2) RLC Entity Re-Establishment Process

When upper layers request an RLC entity re-establishment, the UE shall:
discard all RLC SDUs, RLC SDU segments, and RLC packet data units (RLC PDUs), if any;
stop and reset all timers;
reset all state variables to their initial values.

In related art, the cell handover process is triggered by L3 signaling (i.e., RRC Reconfiguration). For further reduction of the delay in the L3 handover process, a handover process based on L1/L2 measurements/signaling is supported.

Illustratively, the cell handover process based on L1/L2 measurements/signaling includes the following steps:

In step 1, the terminal receives candidate cell configuration from the network side.

Illustratively, the terminal receives configuration information for a plurality of candidate cells from the network side.

In step 2, the terminal performs measurement and reports the measurement results.

In some embodiments, the terminal measures the downlink reference signals of all or part of the candidate cells to obtain beam/cell-level measurement results. Subsequently, the terminal reports the measurement results to the current serving cell (i.e., the source cell) according to the configuration.

The downlink reference signals include synchronization signal and PBCH block (SSB) or channel state information-reference signal (CSI-RS).

In step 3, the terminal receives L1/L2 signaling from the network side and switches to the target cell.

Illustratively, the L1/L2 signaling is used to indicate one of a plurality of candidate cells as the target cell for handover. In some embodiments, the L1/L2 signaling may also be used to indicate/activate a transmission configuration index (TCI) state for the target cell, providing the terminal with beam information for operating in the target cell.

For reduction of the delay in the protocol stack processing during the cell handover process (such as the PDCP re-establishment, the RLC re-establishment, the MAC reset processes introduced above), LTM is introduced, limiting the cell handover scenarios to cells in an intra-distributed unit (intra-DU) under an intra-centralized unit (intra-CU) and to cells in inter-DU.

In the NR protocol stack, L1 includes the PHY layer, which provides transport channels for the MAC layer; L2 includes the MAC layer, the RLC layer, the PDCP layer, and the SDAP layer, wherein the MAC layer provides logical channels for the RLC layer, and the RLC layer provides radio bearers for the PDCP layer. Illustratively, the NR protocol stack also includes L3, which is the RRC layer.

In some embodiments, the PHY layer and the MAC layer may be understood as the lower layers, while the RLC layer, the PDCP layer, the SDAP layer, and the RRC layer may be understood as the upper layers.

In the above scenarios, the PDCP layers of the current serving cell and each candidate cell are processed by the same CU on the network side. In a case where the terminal moves within these cells, security algorithms and keys are not updated, thereby saving the handover delay caused by the PDCP re-establishment process.

Furthermore, for intra-DU cell handover, the RLC layer and the MAC layer are managed by the same DU, and the source cell and candidate cells may reuse the same RLC configuration and MAC configuration. Based on this, it is considered to partially reset/re-establish at least one of the RLC layer or the MAC layer during the LTM process to further reduce the handover process delay.

FIG. 3 illustrates a flowchart of the method for processing information according to some embodiments of the present disclosure, which is applicable to a terminal. The method includes the following processes:

In process 202, MAC is reset or partially reset during the LTM process.

Referring to the above content, to reduce the delay in protocol stack processing during the cell handover process, LTM is considered to be introduced to simplify the protocol layer processing. Based on this, during the LTM process, resetting or partially resetting the MAC may be considered, and subsequently, after the target cell is successfully accessed, the RLC SDU is retransmitted.

In some embodiments, the indication information for resetting or partially resetting the MAC is carried in the LTM handover command.

Alternatively, the indication information for resetting or partially resetting the MAC is carried in the configuration information of the candidate cell/candidate cell group.

In some embodiments, the network device instructs the terminal to reset or partially reset the MAC using the LTM handover command to explicitly indicate the MAC reset. In some embodiments, the network device transmits the configuration information of the candidate cell or candidate cell group to the terminal and carries the indication information for resetting or partially resetting the MAC in the configuration information to implicitly indicate the MAC reset.

Illustratively, during the LTM process, the MAC layer may be processed in the following two ways.

### 1. Resetting the MAC.

Based on this, after successful access to the target cell, the terminal may retransmit the RLC SDU to the target cell.

For example, after access to the target cell, data retransmission to the target cell may be directly performed. Alternatively, after access to the target cell, the terminal waits for indication information from at least one of the lower layer (i.e., the MAC layer or the PHY layer) or the upper layer (i.e., the RRC layer), and after receipt of the indication information, the terminal performs data retransmission based on the indication information.

### 2. Partially Resetting the MAC.

Based on this, after successful access to the target cell, the terminal may determine whether to retransmit the RLC SDU based on the data in the HARQ buffer corresponding to the target cell. For example, in a case where the data in the HARQ buffer is cleared, the terminal retransmits the RLC SDU to the target cell.

Based on the above two processing ways, the delay in protocol stack processing during the cell handover process may be reduced during the LTM process, and the protocol layer processing is simplified, such that the data transmission delay is reduced after the terminal successfully accesses the target cell.

In some embodiments, in a case where the terminal performs partial resetting MAC, corresponding processing may be performed on at least one of a timing advance timer (TAT), a BFR process, a consistent LBT process, data in the HARQ buffer of a serving cell, or a transmission resource of a serving cell.

For example, the terminal receives a first signaling from the network device, wherein the first signaling is used to instruct the terminal to reset or partially reset the MAC during the LTM process. Using the first signaling instructing the terminal to partially reset the MAC as an example: Illustratively, based on the first signaling, the terminal may perform at least one of:
stopping a running TAT;
canceling a triggered BFR and resetting a beam failure indication counter (BFI_COUNTER) corresponding to the BFR;
canceling a triggered consistent LBT failure and resetting a counter corresponding to the consistent LBT failure (LBT_COUNTER);
retaining data of an HARQ entity corresponding to a specified serving cell in an HARQ buffer; or
suspending use of a transmission resource associated with a specified serving cell, wherein the transmission resource includes at least one of: a configured grant (CG), a physical uplink control channel (PUCCH) resource, a physical uplink shared channel (PUSCH) resource, a downlink semi-persistent scheduling (DL SPS) resource, or a sounding reference signal (SRS) resource.

In a case of partially resetting the MAC, the terminal skips performing at least one of:
canceling a triggered BSR procedure;
initializing the Bj of a logical channel; or
canceling a triggered PHR procedure.

Based on the above operations, after the terminal successfully accesses the target cell, in a case where data of an HARQ entity corresponding to a target cell is retained in an HARQ buffer, the terminal may perform resource initialization on the transmission resource of the target cell to initialize/reinitialize at least one of the CG, the PUCCH resource, the PUSCH resource, the SPS resource, or the SRS resource.

The resource initialization performed by the terminal may be implemented as one of:
suspending the resource initialization, and performing the resource initialization after receipt of indication information from a network device and/or expiration of a timer; or
performing the resource initialization, and performing, after receipt of indication information from a network device and/or expiration of a timer, data transmission over a transmission resource acquired by performing the resource initialization.

It should be understood that the above examples are only exemplary examples of partially resetting MAC and do not limit the present disclosure. Additionally, the case of partially resetting MAC is detailed below.

In summary, in the method for transmitting data according to the embodiments of the present disclosure, a processing method for the protocol layer during the LTM process is provided. Based on the processing method for the protocol layer, a data retransmission mechanism is correspondingly provided. Based on this, the terminal may reset or partially reset the MAC during the LTM process, and retransmit the RLC SDU after successful access to the target cell, such that the delay of data transmission is reduced and loss of uplink data is avoided.

Based on FIG. 3, FIG. 4 illustrates a flowchart of the method for processing information according to some embodiments of the present disclosure. Process 202 may be implemented as process 2021.

In process 2021, the MAC is partially reset during the LTM process.

Referring to the above content, during the LTM process, the reset of the MAC layer involves various operations. In some embodiments, process 2021 includes at least one of operations.
Stopping the running TAT.

In some embodiments, the TAT does not include a timer corresponding to a first timing advance group (TAG). The first TAG is at least one of: a TAG associated with the target cell after the terminal performs cell handover; a TAG indicated in the LTM handover command; or a TAG associated with a third serving cell that remains unchanged before and after the cell handover.

In some embodiments, for a carrier aggregation (CA) scenario, the current serving cell corresponding to the terminal includes a primary cell (PCell) and at least one secondary cell (SCell). During the LTM process, only the primary cell change may be indicated while keeping the secondary cell as the serving cell. Based on this, the third serving cell that remains unchanged before and after the cell handover involved in the embodiments of the present disclosure may be understood as the secondary cell in the scenario where the primary cell is changed and the secondary cell remains unchanged (PCell change without SCell change).
Canceling a triggered BFR and resetting a beam failure indication counter corresponding to the BFR, wherein the BFR does not include a BFR triggered by a first serving cell.
Canceling a triggered consistent LBT failure and resetting a counter corresponding to the consistent LBT failure, wherein the consistent LBT failure does not include a consistent LBT failure triggered by the first serving cell.

In some embodiments, the first serving cell is a serving cell that remains unchanged and is in an active state before and after the cell handover. For the understanding of the serving cell that remains unchanged before and after the cell handover, reference may be made to the description of the third serving cell mentioned above and is not described herein any further. The first serving cell is indicated by at least one of the upper layer or the LTM handover command. Illustratively, the upper layer includes the RRC layer.
Retaining data of an HARQ entity corresponding to a second serving cell in an HARQ buffer.

In some embodiments, the second serving cell includes at least one of:
all serving cells before the cell handover;
a source primary cell or a source primary secondary cell before the cell handover;
a serving cell that remains unchanged and is in an active state before and after the cell handover;
a serving cell indicated in the LTM handover command;
a serving cell for which a TAT corresponding to an associated TAG has not stopped running;
a serving cell that is a secondary cell before the cell handover and is a primary cell after the cell handover; or
a serving cell that is a primary cell before the cell handover and is a secondary cell after the cell handover.

In some embodiments, the second serving cell includes at least one of the source primary cell (source PCell), the source primary secondary cell (PSCell), or the source secondary cell (source SCell). In some embodiments, in a case where the TAT corresponding to the TAG associated with a serving cell has not stopped running, the serving cell is determined as the second serving cell.
Suspending use of the CG resource associated with the second serving cell.

In some embodiments, the type of CG resource includes a CG type 1 and a CG type 2. For the CG type 1, the uplink transmission grant is provided by the RRC layer, and the UE stores the configuration as an authorized configuration. For the CG type 2, the uplink transmission grant is provided by the PDCCH, and the configuration is stored or cleared based on the configuration activation or deactivation indication of L1 signaling.
Suspending use of the PUCCH resource associated with second serving cell.
Suspending use of the PUSCH resource associated with the second serving cell.
Suspending use of the DL SPS resource associated with the second serving cell.
Suspending use of the SRS resource associated with the second serving cell.

In some embodiments, the method for processing information according to the embodiments of the present disclosure further includes:

in a case of partially resetting the MAC, skipping performing at least one of: canceling a triggered BSR procedure; initializing Bj of a logical channel; or canceling a triggered PHR procedure.

It is understood that in a case where the terminal performs partially resetting the MAC layer, the terminal does not cancel the triggered BSR procedure, and/or does not initialize the variable of the logical channel, and/or does not cancel the triggered PHR procedure. Alternatively, it is understood that in a case where the terminal partially resets the MAC layer, the terminal continues the triggered BSR procedure, and/or does not change the variable of the logical channel, and/or continues the triggered PHR procedure.

Referring to the above content, in some embodiments, in a case where partially resetting MAC includes caching the HARQ data of the second serving cell, the terminal may perform resource initialization to achieve at least one of data retransmission or new data transmission. In some embodiments, the method for processing information according to the embodiments of the present disclosure further includes the following processes:

In process 204, in a case where data of the HARQ entity corresponding to the second serving cell is retained in the HARQ buffer, resource initialization is performed.

Illustratively, resource initialization includes initializing or reinitializing a transmission resource. The transmission resource includes at least one of a CG, a PUCCH resource, a PUSCH resource, an SPS resource, or an SRS resource.

It should be understood that the resource initialization is performed after the terminal successfully accesses the target cell.

In some embodiments, process 204 may be implemented as at least one of:
initializing or reinitializing the CG;
initializing or reinitializing the PUCCH resource;
initializing or reinitializing the PUSCH resource;
initializing or reinitializing the SPS resource;
initializing or reinitializing the SRS resource;
initializing or reinitializing the CG in a case where first indication information is received;
initializing or reinitializing the PUCCH resource in a case where first indication information is received;
initializing or reinitializing the PUSCH resource in a case where first indication information is received;
initializing or reinitializing the SPS resource in a case where first indication information is received;
initializing or reinitializing the SRS resource in a case where first indication information is received;
initializing or reinitializing the CG in a case where a first timer expires;
initializing or reinitializing the PUCCH resource in a case where a first timer expires;
initializing or reinitializing the PUSCH resource in a case where a first timer expires;
initializing or reinitializing the SPS resource in a case where a first timer expires; or
initializing or reinitializing the SRS resource in a case where a first timer expires.

The first indication information is transmitted by the network device, and the first indication information is used to instruct the terminal to perform resource initialization. The first timer is a timer started after the terminal successfully accesses the target cell.

It should be understood that process 204 may be implemented as: performing resource initialization on the transmission resource in a case where the target cell is successfully accessed; or performing resource initialization on the transmission resource in a case where the target cell is successfully accessed and the first indication information is received; or performing resource initialization on the transmission resource in a case where the target cell is successfully accessed and the first timer expires.

The first timer is used to indicate the duration after which the terminal performs resource initialization. It can be understood that the terminal does not perform resource initialization during the operation of the first timer and performs resource initialization after the first timer expires.

In some embodiments, the method for processing information according to the embodiments of the present disclosure further includes: after expiration of the second timer and/or after receipt of the second indication information, performing data transmission over the initialized or reinitialized resource, wherein the second timer is a timer started after resource initialization.

Similar to the first indication information, the second indication information is transmitted by the network device, and the second indication information is used to instruct the terminal to perform data transmission over the initialized or reinitialized resource.

Similar to the first timer, the second timer is used to indicate the duration after which the terminal performs data transmission over the initialized or reinitialized resource. It can be understood that the terminal does not perform data transmission over the initialized or reinitialized resource during the operation of the second timer, and the terminal performs data transmission over the initialized or reinitialized resource after the second timer expires.

Based on this, in some embodiments, the method for processing information according to the embodiments of the present disclosure may further include: during the operation of the second timer and/or before receipt of the second indication information, perform data transmission over the first resource corresponding to the HARQ process.

It should be understood that the first resource is at least one of a CG, a PUCCH resource, a PUSCH resource, an SPS resource, or an SRS resource. Illustratively, the first resource is the CG.

In some embodiments, the first resource meets at least one of the following conditions: an HARQ buffer corresponding to an HARQ process identification (HPID) associated with the first resource is vacant; or a size of the first resource matches a size of data cached in an HARQ buffer corresponding to an HPID.

In some embodiments, at least one of the first indication information or the second indication information mentioned above is applicable to all second serving cells; or at least one of the first indication information or the second indication information is applicable to the second serving cells indicated by the information. In some embodiments, in a case where at least one of the first indication information or the second indication information is applicable to a second serving cell indicated by the information, at least one of the first indication information or the second indication information carries a serving cell identifier. The serving cell identifier is used to indicate the second serving cell that needs to perform at least one of resource initialization or data transmission.

In some embodiments, at least one of the first timer or the second timer mentioned above may be maintained based on different granularities. In some embodiments, at least one of the first timer or the second timer is maintained per cell group; or at least one of the first timer or the second timer is maintained per serving cell.

In some embodiments, in a case where the first timer is maintained per cell group, after the first timer expires, the terminal performs resource initialization for the fourth serving cell within the cell group; and in a case where the second timer is maintained per cell group, after the second timer expires, the terminal located in the fourth serving cell performs data transmission over the initialized or reinitialized resource.

The fourth serving cell is a serving cell configured with CG and with cached data in the HARQ buffer within the cell group.

It is understood that, in a case where at least one of the first timer or the second timer is maintained per cell group, after expiration of at least one of the first timer or the second timer, the terminal performs at least one of resource initialization or data transmission for the serving cell configured with CG and with cached data in the HARQ buffer within the cell group. In a case where at least one of the first timer or the second timer is maintained per serving cell, after expiration of at least one of the first timer or the second timer, the terminal performs at least one of resource initialization or data transmission for the serving cell.

In summary, in the method for processing information according to the embodiments of the present disclosure, a specific implementation for partially resetting the MAC is provided. In some embodiments of the present disclosure, a specific implementation for resource initialization is also provided, in which the terminal may perform initialization or reinitialization on the transmission resource after successful access to the target cell.

Based on FIG. 3, FIG. 5 illustrates a flowchart of the method for processing information according to some embodiments of the present disclosure. The method for processing information according to the embodiments of the present disclosure further includes the following processes:

In process 206, an RLC SDU is retransmitted to a target cell.

Referring to the above content, after resetting or partially resetting the MAC layer, the terminal may retransmit data to the target cell after successful access to the target cell. The retransmitted data may be the RLC SDU.

In some embodiments, process 206 may be implemented as: after successful access to the target cell, retransmitting the RLC SDU to the target cell; or after receipt of the indication information from at least one of a lower layer or an upper layer, retransmitting the RLC SDU to the target cell.

The lower layer includes the MAC layer or the PHY layer, and the upper layer includes the RRC layer.

It may be understood that during the LTM process, the terminal resets or partially resets the MAC layer. Subsequently, after the terminal successfully accesses the target cell, the terminal may directly retransmit the RLC SDU to the target cell; or the terminal retransmits the RLC SDU based on the indication information from at least one of the lower layer or the upper layer.

In some embodiments, the RLC SDU is retransmitted in a case where: the MAC is reset; or the MAC is partially reset, and data in an HARQ buffer is cleared.

It may be understood that during the LTM process, the terminal resets or partially resets the MAC layer. Subsequently, after resetting the MAC and successfully accessing the target cell, the terminal may directly retransmit the RLC SDU to the target cell; or after resetting the MAC, the terminal retransmits the RLC SDU based on the indication information from at least one of the lower layer or the upper layer; or after partially resetting the MAC, clearing the data in the HARQ buffer, and successfully accessing the target cell, the terminal may directly retransmit the RLC SDU to the target cell; or after partially resetting the MAC and clearing the data in the HARQ buffer, the terminal retransmits the RLC SDU based on the indication information from at least one of the lower layer or the upper layer.

In some embodiments, the RLC SDU includes at least one of: the RLC SDU delivered to the lower layer within the transmission window and with unacknowledged transmission status; or the RLC SDU indicated as a negative acknowledgement (NACK) in the STATUS PDU.

In some embodiments, the RLC SDU includes the RLC SDU indicated as NACK in the STATUS PDU. Based on this, the method for processing information according to the embodiments of the present disclosure further includes: triggering polling before receipt of the STATUS PDU transmitted by the network device (autonomously).

In some embodiments, the polling is triggered under at least one of the following conditions and/or timings:
The terminal successfully accesses the target cell.
The terminal receives the signaling for cell handover.

The signaling is the LTM handover command, or other dedicated signaling, or carried in other signaling.
Before expiration of the first timer, the terminal does not meet the first condition for triggering polling, wherein the first timer is a timer started after the terminal successfully accesses the target cell.

In some embodiments, the first condition for triggering polling includes at least one of the following items:
the number of acknowledged mode data (AMD) PDUs delivered to the lower layer reaches a first threshold;
the number of bytes in an AMD PDU reaches a second threshold;
a transmission memory and a retransmission memory are vacant;
a transmission window for transmitting data is fully occupied;
a polling retransmission timer expires, and a transmission memory and a retransmission memory are vacant; or
a polling retransmission timer expires, and a transmission window for transmitting data is fully occupied.

The first threshold may be a poll PDU threshold, the second threshold may be a poll byte threshold, and the polling retransmission timer may be a t-PollRetransmit timer.
The terminal receives indication information from at least one of the lower layer or the upper layer.

In some embodiments, the lower layer includes the MAC layer or the PHY layer, and the upper layer includes the RRC layer.

In summary, in the method for processing information according to the embodiments of the present disclosure, by resetting or partially resetting the MAC, the terminal is allowed to retransmit the RLC SDU to the target cell after successful access to the target cell. In some embodiments, the embodiments of the present disclosure provide multiple retransmission conditions for the RLC SDU.

It should be understood that the various implementations for RLC SDU retransmission according to the embodiments of the present disclosure may be combined with the various implementations for partial reset according to the above embodiments, and any combination implementation is within the protection scope of the present disclosure and are not described herein any further.

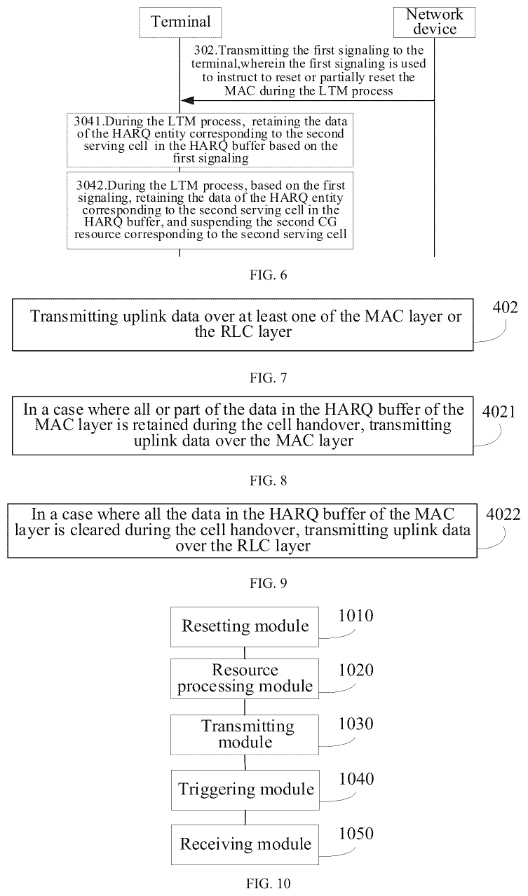

Based on the above embodiments, two optional implementations for the protocol layer processing and data retransmission mechanism during the LTM process. FIG. 6 illustrates a flowchart of the method for processing information according to some embodiments of the present disclosure, which includes the following processes:

In process 302, the network device transmits the first signaling to the terminal.

Illustratively, the first signaling is used to instruct to reset or partially reset the MAC during the LTM process.

The first signaling may be the LTM handover command, or carried in at least one of the MAC control element (MAC CE) or downlink control information (DCI).

In some embodiments, the first signaling is also used to instruct the terminal to switch to the target cell.

Illustratively, based on the first signaling, the terminal has the following two optional processes to perform. It should be understood that process 3041 and process 3042 are performed alternatively and are not performed simultaneously.

In process 3041, during the LTM process, the data of the HARQ entity corresponding to the second serving cell is retained in the HARQ buffer based on the first signaling.

For example, the second serving cell is the source primary cell (source PCell) before the handover, and this cell is marked as serving cell 1. After receipt of the first signaling, by partially resetting MAC, the terminal retains the data of the HARQ entity corresponding to serving cell 1 in the HARQ buffer.

After completing partially resetting MAC, the terminal accesses the target cell. In some embodiments, in a case where the target cell is configured with CG, to prevent the data cached in the HARQ buffer from being overwritten, the terminal may suspend use of the CG for new data transmission.

Two optional implementations as follows:

(1) After access to the second serving cell, the terminal suspends the initialization or reinitialization of the second CG resource corresponding to the second serving cell.

In this implementation, after successful access to the target cell, the terminal suspends the resource initialization to prevent the data in the HARQ buffer from being overwritten. Referring to the above content, the resource initialization may be performed in the following situations: after the first indication information is received; and/or after the first timer expires.

For details of the resource initialization, reference may be made to the above content, which are not described herein any further.

(2) After access to the second serving cell, the terminal performs the initialization or reinitialization of the second CG resource corresponding to the second serving cell, and suspends use of the third CG resource acquired by performing the initialization or reinitialization.

In this implementation, after successful access to the target cell, the terminal may immediately perform the resource initialization on the second CG resource, but after performing the resource initialization, suspends use of the third CG resource acquired by performing the initialization or reinitialization. Referring to the above content, the third CG resource may be used after the second timer expires.

Illustratively, the example based on process 3041 may be implemented as follows:

In step 1, the UE receives the first signaling from the network side;

The first signaling instructs the UE to switch to the target cell.

Subsequently, the UE determines to perform the MAC reset based on the indication information of the first signaling or pre-configuration information. For example, by partially resetting MAC, the UE retains the data of the HARQ entity corresponding to serving cell 1 (serving cell #1) in the HARQ buffer. Serving cell #1 is the source PCell before the handover. In step 2, the UE accesses the target cell.

The configuration of target cell includes CG. Illustratively, the CG is a CG type-1 resource. To prevent data cached in the HARQ buffer being overwritten due to the UE transmitting new data using the CG type-1 resource, the UE MAC layer suspends use of the CG type-1 resource for new data transmission.

In some embodiments, the following two schemes are provided:
a) The initialization/reinitialization of CG resource is suspended.
b) After access to the target cell, the UE performs the initialization/reinitialization of the CG resource, and suspends use of the CG resource.

In process 3042, during the LTM process, based on the first signaling, the data of the HARQ entity corresponding to the second serving cell is retained in the HARQ buffer, and the second CG resource corresponding to the second serving cell is suspended.

For example, the second serving cell is the source secondary cell (source SCell) before the handover, and the configuration of the source secondary cell remains unchanged after the handover, and this cell is marked as serving cell 2. After receipt of the first signaling, by partially resetting MAC, the terminal retains the data of the HARQ entity corresponding to serving cell 2 in the HARQ buffer, and suspends use of the second CG resource.

Upon completion of partially resetting the MAC, the terminal accesses the target cell. Similarly, to prevent the data cached in the HARQ buffer from being overwritten, the terminal may suspend use of the CG for new data transmission.

Two optional implementations are provided as follows:

(1) After access to the second serving cell, the terminal suspends the initialization or reinitialization of the second CG resource corresponding to the second serving cell.

In this implementation, after successful access to the target cell, the terminal suspends the resource initialization to prevent the data in the HARQ buffer from being overwritten. Referring to the above content, the resource initialization may be performed in the following situations: after the first indication information is received; and/or after the first timer expires.

For details of the resource initialization, reference may be made to the above content, which are not described herein any further.

(2) After access to the second serving cell, the terminal acquires the third CG resource by performing reinitialization of the second CG resource corresponding to the second serving cell, and retransmits the data cached in the HARQ buffer using the third CG resource.

In this implementation, after successful access to the target cell, the terminal may immediately perform the resource initialization on the second CG resource, and retransmit the data using the third CG resource acquired by performing initialization or reinitialization.

Illustratively, the example based on process 3042 may be implemented as follows:

In step 1, the UE receives the first signaling from the network side.

The first signaling instructs the UE to switch to the target cell.

Subsequently, the UE determines perform the MAC reset based on the indication information of the first signaling or pre-configuration information. For example, by partially resetting MAC, the UE retains the data of the HARQ entity corresponding to serving cell 2 (serving cell #2) in the HARQ buffer, and suspends the CG resources of serving cell #2. Serving cell #2 is the source PCell before the handover, and the configuration of the SCell remains unchanged after the handover.

In step 2, the UE accesses the target cell.

Illustratively, for the CG resources of serving cell #2, the action of the UE includes:
a) suspending the initialization/reinitialization of CG resources; and
b) reinitializing CG resources and retransmitting the data cached in the HARQ buffer using CG resources.

Illustratively, HPID #1 is configured to be associated with CG resources, and the corresponding HARQ buffer contains cached data. After the handover is completed, the UE reinitializes the CG resources of serving cell #2 and reuses the CG resources associated with HPID to retransmit the data in the HARQ buffer. In some embodiments, whether to use CG resources for data retransmission is based on the explicit indication reported by the network or protocol pre-definition.

In summary, in the method for processing information according to the embodiments of the present disclosure, two optional implementations for the protocol layer processing and data retransmission mechanism during the LTM process are provided.

Referring to the above content, the embodiments of the present disclosure also provide a data retransmission mechanism. In some embodiments, based on the processing of the MAC layer during the LTM process, the terminal may implement data transmission over at least one of the MAC layer or the RLC layer. The data transmission implemented over at least one of the MAC layer or the RLC layer includes data retransmission and new data transmission.

FIG. 7 illustrates a flowchart of the method for transmitting data according to some embodiments of the present disclosure, which is applicable to a terminal and includes the following processes:

In process 402, uplink data is transmitted over at least one of the MAC layer or the RLC layer.

In some embodiments, process 402 may be implemented as follows:

Based on the processing of the data in the HARQ buffer of the MAC layer during the cell handover, it may be determined to transmit uplink data over at least one of the MAC layer or the RLC layer.

For example, in a case where all or part of the data in the HARQ buffer of the MAC layer is retained during the LTM process, it may be determined to transmit uplink data over the MAC layer. Similarly, in a case where all the data in the HARQ buffer of the MAC layer is cleared during the LTM process, it may be determined to transmit uplink data over the RLC layer.

Illustratively, the cell handover process involved in the embodiments of the present disclosure may be understood as the cell handover performed after the processing of the protocol layer during the LTM process. For related description of the processing of the protocol layer during the LTM process, reference may be made to the above content; or reference may be made to the description of the specific implementations below.

Two optional transmission modes for uplink data are provided as follows:

First transmission mode: Uplink data is transmitted over the MAC layer.

Referring to FIG. 8, process 402 may be implemented as process 4021.

In process 4021, in a case where all or part of the data in the HARQ buffer of the MAC layer is retained during the cell handover, uplink data is transmitted over the MAC layer.

The processing of the data in the HARQ buffer may be performed based on the signaling from the network device.

In some embodiments, the method for transmitting data according to the embodiments of the present disclosure further includes: during the cell handover, receiving the second signaling from the network device, wherein the second signaling is used to instruct the MAC layer to retain the data in the HARQ buffer in the first HARQ entity.

In some embodiments, the second signaling is also used to instruct the terminal to switch to the target cell or the target cell group.

In some embodiments, the second signaling is carried in at least one of the MAC CE or the DCI.

In some embodiments, the second signaling is the LTM handover command.

In some embodiments, the first HARQ entity is the HARQ entity corresponding to at least one of the primary cell or the secondary cell. The secondary cell is not released and remains active before and after the cell handover.

In some embodiments, for the HARQ process associated with the CG resource in the first HARQ entity, the terminal may also perform at least one of the following steps:
in a case where the CGT is not running, the terminal clears the HARQ process associated with the CG in the first HARQ entity;
in a case where the CGT is running, the terminal stops the CGT;
in a case where the CGT is running, the terminal keeps running the CGT;
in a case where the CGT is running, the terminal suspends the CGT;
in a case where the CGRT is running, the terminal stops the CGRT;
in a case where the CGRT is running, the terminal keeps running the CGRT; or in a case where the CGRT is running, the terminal suspends the CGRT.

At least one of the CGT or the CGRT is a timer associated with the CG. The CGT and the CGRT are different timers. Illustratively, the CGT may be the configuredGrantTimer, and the CGRT may be the cg-Retransmission Timer.

In a case where all or part of the data in the HARQ buffer of the MAC layer is retained during the cell handover, after successful access to the target cell or the target cell group, the terminal may perform data retransmission based on the dynamic scheduling of the target cell to prevent the data in the HARQ buffer from being overwritten.

In some embodiments, process 4021 may be implemented in one of the following two ways:

Implementation 1: The retransmission is performed based on the dynamic scheduling of the target cell.

Illustratively, process 4021 may be implemented as: in a case where all or part of the data in the HARQ buffer of the MAC layer is retained during the cell handover, retransmitting the data in the HARQ buffer retained in the first HARQ entity based on the dynamic scheduling of the target cell.

In some embodiments, in a case where the HPID in the first HARQ entity is associated with the third CG resource configured for the target cell, the third CG resource is not used for new data transmission before receipt of the indication information or before expiration of the first timer, wherein the first timer is a timer started after the terminal successfully accesses the target cell.

Based on this, the terminal may also use the third CG resource for new data transmission after expiration of the first timer.

The HARQ buffer of the HPID is vacant; or the HPID is associated with the third CG resource before the cell handover, and when the terminal receives the signaling for the cell handover process, the CGT associated with the third CG resource is not running.

In some embodiments, in a case where the remaining HPID other than the first HPID in the first HARQ entity is associated with the fourth CG configured for the target cell, the fourth CG is not used for new data transmission before receipt of the indication information or before expiration of the first timer.

Implementation 2: At least one data retransmission or new data transmission is performed based on the CG.

Illustratively, process 4021 may be implemented as:
in a case where the data in the HARQ buffer of the MAC layer is retained during the cell handover, and at least one of the CGT or the CGRT is restarted, performing, according to the running state of at least one of the CGT or the CGRT, at least one of data retransmission or new data transmission on the data in the HARQ buffer based on the CG; or
in a case where all or part of the data in the HARQ buffer of the MAC layer is retained during the cell handover, and at least one of the CGT or the CGRT is recovered, performing, according to the running state of at least one of the CGT or the CGRT, data retransmission and/or new data transmission on the data in the HARQ buffer based on the CG; or
in a case where all or part of the data in the HARQ buffer of the MAC layer is retained during the cell handover, and before at least one of the CGT or the CGRT is restarted, performing data retransmission and/or new data transmission on the data in the HARQ buffer based on the CG; or
in a case where all or part of the data in the HARQ buffer of the MAC layer is retained during the cell handover, and before at least one of the CGT or the CGRT is recovered, performing data retransmission and/or new data transmission on the data in the HARQ buffer based on the CG.

At least one of the CGT or the CGRT is a timer associated with the CG, the CGT and the CGRT are different timers, and the CG is associated with the first HARQ.

In some embodiments, the data in the HARQ buffer is retransmitted based on the CG of the target cell.

The CG meets at least one of the following conditions: the HARQ buffer corresponding to the HPID associated with the CG is vacant; or before and after the cell handover, at least one of the CGT or the CGRT is not running, wherein at least one of the CGT or the CGRT is a timer corresponding to the HPID associated with the CG.

In some embodiments, the retransmission of the data in the HARQ buffer is performed in a case where at least one of the following conditions is met:
before and after the cell handover, the CG configured for the serving cell corresponding to the first HARQ entity remains unchanged; or
before and after the cell handover, at least one of the CGT or the CGRT is running, wherein at least one of the CGT or the CGRT is a timer corresponding to the HPID associated with the CG configured for the serving cell, and the CGT and the CGRT are different timers.

In some embodiments, the method for transmitting data according to the embodiments of the present disclosure further includes: performing new data transmission based on the CG of the target cell. The new data transmission is performed in a case where at least one of the following conditions is met: the data transmission indication is received from the network device; or the first timer expires, wherein the first timer is a timer started after the terminal successfully accesses the target cell.

Illustratively, the example based on process 4021 may be implemented in one of the following two ways:

### Implementation 1:

In step 11, the UE receives the third signaling from the network side, instructing the MAC layer to retain the data in the HARQ buffer in the first HARQ entity.

For the HARQ process associated with the CG resources in the first HARQ entity, the action of the UE further includes:
a) for the HARQ process associated with the CG resource in the first HARQ entity, in a case where the CGT (configuredGrantTimer) is not running, clearing the HARQ buffer associated with the HARQ process; and/or
b) for the HARQ process associated with the CG resource in the first HARQ entity, in a case where at least one of the CGT or the CGRT (cg-RetransmissionTimer) is running, stopping at least one of the CGT or the CGRT.

The third signaling is used to instruct the UE to switch to the target cell/cell group. The third signaling is carried in at least one of the MAC CE or the DCI. The first HARQ entity is at least one of the HARQ entity corresponding to the PCell or the HARQ entity corresponding to the SCell. In some embodiments, the SCell is not released and remains active before and after the handover.

In step 21, the UE accesses the target cell/cell group, and the UE retransmits the data in the HARQ buffer of the first HARQ entity based on the dynamic scheduling of the target cell.

In a case where the HPID in the first HARQ entity is associated with the CG configured for the target cell (the CG type includes at least one of the CG type 1 or the CG type 2), to prevent the data in the HARQ buffer from being overwritten by new data caused by the UE performing new data transmission over the CG of the target cell before scheduling retransmission by the network, the following three optional solutions are proposed:

Solution 1: Before receipt of the first indication, the UE does not transmit new data using the CG configured for the target cell.

Solution 2: After access to the target cell, the UE start the second timer, and before the second timer expires, the UE does not transmit new data using the CG configured for the target cell.

Solution 3: After access to the target cell, the UE may transmit new data using the CG resource associated with a part of HPIDs. The method for determining the part of the HPIDs includes: 1) the HARQ buffer corresponding to the HPID is vacant; 2) the HPID is also associated with the CG resource before the handover, and the corresponding CGT is not running when the handover command is received. The CG resources corresponding to the remaining HPIDs follow Solution 1 or Solution 2.

### Implementation 2:

In step 12, the UE receives the third signaling from the network side, instructing the MAC layer to retain the data in the HARQ buffer in the first HARQ entity.

For the HARQ process associated with the CG resource in the first HARQ entity, the action of the UE further includes:
a) for the HARQ process associated with the CG resource in the first HARQ entity, in a case where the CGT (configuredGrantTimer) is not running, clearing the HARQ buffer associated with the HARQ process; and/or
b) for the HARQ process associated with the CG resource in the first HARQ entity, in a case where at least one of the CGT or the CGRT (cg-Retransmission Timer) is running, the action of the UE includes:
i. stopping at least one of the CGT or the CGRT; or
ii. keeping running at least one of the CGT or the CGRT; or
iii. suspending at least one of the CGT or the CGRT.

The third signaling is used to instruct the UE to switch to the target cell/cell group. The third signaling is carried in at least one of the MAC CE or the DCI. The first HARQ entity is at least one of the HARQ entity corresponding to the PCell or the HARQ entity corresponding to the SCell. In some embodiments, the SCell is not released and remains active before and after the handover.

In step 22, after the UE accesses the target cell/cell group, the action of the UE includes:
a) for the HPID associated with the CG resource in the first HARQ entity, restarting/recovering the CGT/CGRT (for items i and iii in step 12), and determining to use the CG resource for at least one of new transmission or retransmission according to the running states of the CGRT and the CGT; and
b) for the HPID associated with the CG resources in the first HARQ entity, before restarting/recovering the CGT/CGRT (for items i and iii in step 12), performing new transmission/retransmission of the data in the HARQ buffer using the CG resource.

Second transmission mode: Uplink data is transmitted over the RLC layer.

Referring to FIG. 9, process 402 may be implemented as process 4022.

In process 4022, in a case where all the data in the HARQ buffer of the MAC layer is cleared during the cell handover, uplink data is transmitted over the RLC layer.

The processing of the data in the HARQ buffer may be performed based on the signaling transmitted by the network device.

In some embodiments, the method for transmitting data according to the embodiments of the present disclosure further includes: receiving the third signaling from the network device during the cell handover, wherein the third signaling is used to instruct the MAC layer to clear the data in the HARQ buffer.

In some embodiments, the third signaling is also used to instruct the terminal to switch to the target cell or the target cell group.

In some embodiments, the third signaling is carried in at least one of the MAC CE or the DCI.

In some embodiments, the third signaling is the LTM handover command.

Referring to the above content, in some embodiments, process 4022 may be implemented as follows:

In a case where all the data in the HARQ buffer of the MAC layer is cleared during the cell handover, the RLC SDU is retransmitted.

In some embodiments, the RLC SDU includes at least one of: an RLC SDU delivered to the lower layer within the transmission window and with unacknowledged transmission status; or an RLC SDU indicated as NACK in the STATUS PDU.

For the related description of the retransmission of the RLC SDU and the polling triggered before the terminal receives the STATUS PDU from the network device, reference may be made to the above content, which are not described herein any further.

Illustratively, the example based on process 4022 may be implemented as follows:

In step 1, the UE receives the third signaling from the network side, indicating clearing the data in the HARQ buffer of the MAC layer.

In step 2, after successful access to the target cell, the UE retransmits the RLC SDU.

The retransmitted RLC SDU includes at least one of:

Scheme 1: The RLC SDU delivered to the lower layer within the transmission window and with unacknowledged transmission status.

Scheme 2: The RLC SDU indicated as NACK in the STATUS PDU.

In step 3, for scheme 2 in step 2, polling is triggered before the UE receives the STATUS PDU from the network side.

The polling is triggered under at least one of the following conditions and/or timings:
a) The UE successfully accesses the target cell.
b) The UE receives the LTM handover command.
c) After successful access to the target cell, the UE starts the first timer, and in a case where the UE does not receive the STATUS PDU autonomously transmitted by the network and does not meet the condition for triggering polling before the first timer expires, the UE triggers polling.

Illustratively, the condition for triggering polling include the following items: 1) the number of AMD PDUs delivered to the lower layer reaches a threshold (poll PDU); or 2) the number of bytes in an AMD PDU delivered to the lower layer reaches a threshold (poll Byte); or 3) Both the transmission memory and retransmission memory are vacant; or 4) the transmission window is fully occupied; or 5) the t-PollRetransmit expires, and item 3) or item 4) is met).

In summary, in the method for transmitting data according to the embodiments of the present disclosure, a data transmission mechanism based on the LTM process is provided, including data retransmission and new data transmission. In some embodiments, in a case where all or part of the data in the HARQ buffer of the MAC layer is retained during the cell handover, the unacknowledged or unsuccessfully received data is retransmitted over the MAC layer; or in a case where all the data in the HARQ buffer of the MAC layer is cleared during the cell handover, the RLC SDU is retransmitted over the RLC layer.

It should be understood that the method for processing information and the method for transmitting data according to the above embodiments may be implemented independently or in combination, and any combination implementation is within the protection scope of the present disclosure, which is not described herein any further.

The following are the apparatus embodiments of the present disclosure. For details not described in the apparatus embodiments, reference may be made to the descriptions in the method embodiments above, which are not described herein any further.

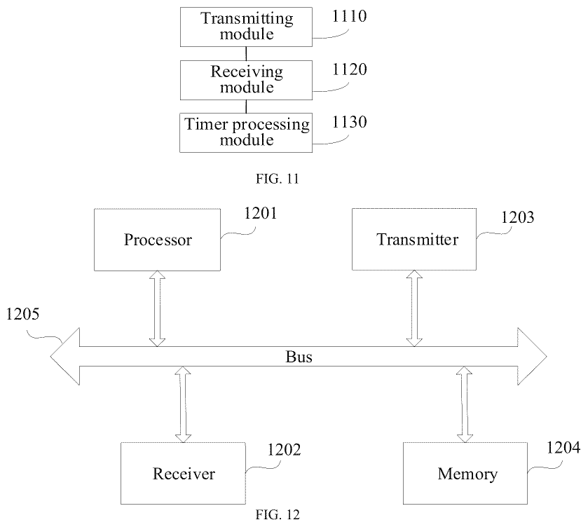

FIG. 10 illustrates a schematic diagram of an apparatus for processing information according to some embodiments of the present disclosure.

The apparatus includes: a resetting module 1010, configured to reset or partially reset MAC during an LTM process.

In some embodiments, the resetting module 1010 is configured to perform at least one of: stopping a running TAT; canceling a triggered BFR and resetting a beam failure indication counter corresponding to the BFR, wherein the triggered BFR does not include a BFR triggered by a first serving cell; canceling a triggered consistent LBT failure and resetting a counter corresponding to the triggered consistent LBT failure, wherein the triggered consistent LBT failure does not include a consistent LBT failure triggered by a first serving cell; retaining data of an HARQ entity corresponding to a second serving cell in an HARQ buffer; suspending use of a CG associated with a second serving cell; suspending use of a PUCCH resource associated with a second serving cell; suspending use of a PUSCH resource associated with a second serving cell; suspending use of a DL SPS resource associated with a second serving cell; or suspending use of an SRS resource associated with a second serving cell.

In some embodiments, the TAT does not include a timer corresponding to a first TAG.

In some embodiments, the first TAG is at least one of: a TAG associated with a target cell to which the apparatus performs cell handover; a TAG indicated in an LTM handover command; or a TAG associated with a third serving cell that remains unchanged before and after the cell handover.

In some embodiments, the first serving cell is a serving cell that remains unchanged and is in an active state before and after the cell handover.

In some embodiments, the first serving cell is indicated by at least one of an upper layer or an LTM handover command.

In some embodiments, the second serving cell includes at least one of: all serving cells before the cell handover; a source primary cell or a source primary secondary cell before the cell handover; a serving cell that remains unchanged and is in an active state before and after the cell handover; a serving cell indicated in an LTM handover command; a serving cell for which a TAT corresponding to an associated TAG has not stopped running; a serving cell that is a secondary cell before the cell handover and is a primary cell after the cell handover; or a serving cell that is a primary cell before the cell handover and is a secondary cell after the cell handover.

In some embodiments, a type of CG resource includes a CG type 1 and a CG type 2.

In some embodiments, in a case of partially resetting the MAC, the apparatus skips performing at least one of: canceling a triggered BSR procedure; initializing Bj for a logical channel; or canceling a triggered PHR procedure.

In some embodiments, the apparatus further includes: a resource processing module 1020, configured to perform resource initialization in a case where the data of the HARQ entity corresponding to the second serving cell is retained in the HARQ buffer.

In some embodiments, the resource processing module 1020 is configured to perform at least one of: initializing or reinitializing the CG; initializing or reinitializing the PUCCH resource; initializing or reinitializing the PUSCH resource; initializing or reinitializing the SPS resource; initializing or reinitializing the SRS resource; initializing or reinitializing the CG resource in a case where the first indication information is received; or initializing or reinitializing the CG resource in a case where the first timer expires, wherein the first timer is a timer started after the device successfully accesses the target cell.

In some embodiments, the apparatus further includes: a transmitting module 1030, configured to perform data transmission over an initialized or reinitialized resource after expiration of a second timer and/or after receipt of second indication information; wherein the second timer is a timer started after resource initialization.

In some embodiments, the transmitting module 1030 is further configured to: perform data transmission over a first resources corresponding to an HARQ process during operation of the second timer and/or before receipt of the second indication information.

In some embodiments, the first resource meets at least one of: an HARQ buffer corresponding to an HARQ process identification (HPID) associated with the first resources is vacant; or a size of the first resource matches a size of data cached in an HARQ buffer corresponding to an HPID.

In some embodiments, at least one of the first indication information or the second indication information is applicable to all second serving cells; or at least one of the first indication information or the second indication information is applicable to the second serving cell indicated by the information.

In some embodiments, at least one of the first indication information or the second indication information carries a serving cell identifier.

In some embodiments, at least one of the first timer or the second timer is maintained per cell group; or at least one of the first timer or the second timer is maintained per serving cell.

In some embodiments, in a case where the first timer is maintained per cell group, after expiration of the first timer, the apparatus performs resource initialization for a fourth serving cell within the cell group; wherein the fourth serving cell is a serving cell configured with CG and with cached data in the HARQ buffer within the cell group.

In some embodiments, in a case where the second timer is maintained per cell group, after the second timer expires, the apparatus located in a third serving cell performs data transmission over the initialized or reinitialized resource; wherein the third serving cell is a serving cell configured with a transmission resource and with cached data in the HARQ buffer within the cell group.

In some embodiments, the apparatus further includes: a transmitting module 1030, configured to retransmit an RLC SDU to a target cell.

In some embodiments, the RLC SDU is retransmitted in a case where: the MAC is reset; or the MAC is partially reset, and data in an HARQ buffer is cleared.

In some embodiments, the transmitting module 1030 is configured to retransmit the RLC SDU to the target cell after successful access to the target cell; or retransmit the RLC SDU to the target cell after receipt of the indication information from at least one of a lower layer or an upper layer.

In some embodiments, the RLC SDU includes at least one of: an RLC SDU delivered to a lower layer within a transmission window and with unacknowledged transmission status; an RLC SDU indicated as a NACK in the STATUS PDU.

In some embodiments, the apparatus further includes: a triggering module 1040, configured to trigger polling before receipt of the STATUS PDU from the network device.

In some embodiments, the polling is triggered under at least one of the following conditions and/or timings: the apparatus successfully accesses the target cell; the apparatus receives signaling for cell handover; before expiration of a first timer, the apparatus does not meet a first condition for triggering polling, wherein the first timer is a timer started after the apparatus successfully accesses the target cell; or the indication information is received from at least one of the lower layer or the upper layer.

In some embodiments, the first condition for triggering polling includes at least one of the following items: the number of AMD PDUs delivered to the lower layer reaches a first threshold; the number of bytes in an AMD PDU reaches a second threshold; both the transmission memory and retransmission memory are vacant; the transmission window for transmitting data is fully occupied; the polling retransmission timer expires, and both the transmission memory and retransmission memory are vacant; or the polling retransmission timer expires, and the transmission window for transmitting data is fully occupied.

In some embodiments, indication information for resetting or partially resetting the MAC is carried in an LTM handover command; or indication information for resetting or partially resetting the MAC is carried in the configuration information of a candidate cell/a candidate cell group.

In some embodiments, the apparatus further includes: a receiving module 1050, configured to receive first signaling from the network device; wherein the first signaling is used to instruct to reset or partially reset the MAC during the LTM process.

In some embodiments, the resetting module 1010 is configured to retain the data of the HARQ entity corresponding to the second serving cell in the HARQ buffer based on the first signaling during the LTM process.

In some embodiments, after access to the second serving cell, the apparatus is configured to suspend the initialization or reinitialization of the second CG resource corresponding to the second serving cell.

In some embodiments, after access to the second serving cell, the apparatus is configured to perform the initialization or reinitialization of the second CG resource corresponding to the second serving cell, and suspends use of a third CG resource acquired by performing initialization or reinitialization.

In some embodiments, the resetting module 1010 is configured to: retain the data of the HARQ entity corresponding to the second serving cell in the HARQ buffer based on the first signaling during the LTM process; and suspend use of the second CG resource corresponding to the second serving cell.

In some embodiments, after access to the second serving cell, the apparatus is configured to suspend the initialization or reinitialization of the second CG resource corresponding to the second serving cell.

In some embodiments, after access to the second serving cell, the apparatus is configured to acquire a third CG resource by performing the reinitialization of the second CG resource corresponding to the second serving cell, and retransmit the data cached in the HARQ buffer using the third CG resource.

FIG. 11 illustrates a schematic diagram of the apparatus for transmitting data according to some embodiments of the present disclosure.

The apparatus includes: a transmitting module 1110, configured to transmit uplink data over at least one of a MAC layer or an RLC layer.

In some embodiments, the transmitting module 1110 is configured to determine to transmit uplink data over at least one of the MAC layer or the RLC layer based on the processing of the data in the HARQ buffer of the MAC layer during the cell handover.

In some embodiments, the transmitting module 1110 is configured to transmit uplink data over the MAC layer in a case where all or part of the data in the HARQ buffer of the MAC layer is retained during the cell handover.

In some embodiments, the apparatus further includes: a receiving module 1120, configured to receive the second signaling from the network device during the cell handover; wherein the second signaling is used to instruct the MAC layer to retain the data in the HARQ buffer in the first HARQ entity.

In some embodiments, the apparatus further includes: a timer processing module 1130, configured to perform at least one of: in a case where the CGT is not running, clearing the HARQ process associated with the CG in the first HARQ entity; in a case where the CGT is running, stopping the CGT; in a case where the CGT is running, keeping running the CGT; in a case where the CGT is running, suspending the CGT; in a case where the CGRT is running, stopping the CGRT; in a case where the CGRT is running, keeping running the CGRT; or in a case where the CGRT is running, suspending the CGRT; wherein at least one of the CGT or the CGRT is a timer associated with the CG, and the CGT and the CGRT are different timers.

In some embodiments, the second signaling is also used to instruct the apparatus to switch to the target cell or the target cell group.

In some embodiments, the second signaling is carried in at least one of the MAC CE or the DCI.

In some embodiments, the second signaling is the LTM handover command.

In some embodiments, the first HARQ entity is the HARQ entity corresponding to at least one of the primary cell or the secondary cell.

In some embodiments, the secondary cell is not released and remains active before and after the cell handover.

In some embodiments, the transmitting module 1110 is configured to retransmit the data in the HARQ buffer retained in the first HARQ entity based on the dynamic scheduling of the target cell in a case where all or part of the data in the HARQ buffer of the MAC layer is retained during the cell handover.

In some embodiments, the transmitting module 1110 is configured to:
in a case where all or part of the data in the HARQ buffer of the MAC layer is retained during the cell handover, and restarting at least one of the CGT or the CGRT, perform data retransmission and/or new data transmission on the data in the HARQ buffer based on the CG according to the running state of at least one of the CGT or the CGRT in a case where all or part of the data in the HARQ buffer of the MAC layer is retained during the cell handover, and restarting at least one of the CGT or the CGRT; or
in a case where all or part of the data in the HARQ buffer of the MAC layer is retained during the cell handover, and recovering at least one of the CGT or the CGRT, perform data retransmission and/or new data transmission on the data in the HARQ buffer based on the CG according to the running state of at least one of the CGT or the CGRT; or
in a case where all or part of the data in the HARQ buffer of the MAC layer is retained during the cell handover, and before restarting at least one of the CGT or the CGRT, perform data retransmission and/or new data transmission on the data in the HARQ buffer based on the CG; or
in a case where all or part of the data in the HARQ buffer of the MAC layer is retained during the cell handover, and before recovering at least one of the CGT or the CGRT, perform data retransmission and/or new data transmission on the data in the HARQ buffer based on the CG.

At least one of the CGT or the CGRT is a timer associated with the CG, the CGT and the CGRT are different timers, and the CG is associated with the first HARQ.

In some embodiments, the data in the HARQ buffer is retransmitted based on the CG of the target cell.

In some embodiments, the data in the HARQ buffer is retransmitted in a case where at least one of the following conditions is met: before and after the cell handover, the CG configured by the serving cell corresponding to the first HARQ entity remains unchanged; or at least one of the CGT or the CGRT is running before and after the cell handover, wherein at least one of the CGT or the CGRT is a timer corresponding to the HPID associated with the CG configured by the serving cell.

In some embodiments, the transmitting module 1110 is further configured to perform new data transmission based on the CG of the target cell.

In some embodiments, the new data transmission is performed in a case where at least one of the following conditions is met: the data transmission indication is received from the network device; or the first timer expires, wherein the first timer is a timer started after the apparatus successfully accesses the target cell.

In some embodiments, the CG meets at least one of the following conditions: the HARQ buffer corresponding to the HPID associated with the CG is vacant; or at least one of the CGT or the CGRT is not running before and after the cell handover, wherein at least one of the CGT or the CGRT is a timer corresponding to the HPID associated with the CG.

In some embodiments, the transmitting module 1110 is configured to transmit uplink data over the RLC layer in a case where all the data in the HARQ buffer of the MAC layer is cleared during the cell handover.

In some embodiments, the apparatus further includes: a receiving module 1120, configured to receive the third signaling from the network device during the cell handover; wherein the third signaling is used to instruct the MAC layer to clear the data in the HARQ buffer.

In some embodiments, the transmitting module 1110 is configured to retransmit the RLC SDU in a case where all the data in the HARQ buffer of the MAC layer is cleared during the cell handover.

FIG. 12 illustrates a schematic structural diagram of a communication device (terminal or network device) according to some embodiments of the present disclosure. The communication device includes: a processor 1201, a receiver 1202, a transmitter 1203, a memory 1204, and a bus 1205.

The processor 1201 includes one or more processing cores, and the processor 1201 runs various functional applications and performs information processing by running software programs and modules.

The receiver 1202 and the transmitter 1203 may be implemented as a communication component. The communication component may be a communication chip.

The memory 1204 is connected to the processor 1201 via the bus 1205.

The memory 1204 may be configured to store at least one instruction. The processor 1201 is configured to execute the at least one instruction to perform the processes of the method for processing information in the method embodiments as described above, or perform the processes of the method for transmitting data in the method embodiments as described above.

In addition, the memory 1204 may be implemented using any type of volatile or non-volatile storage device or a combination thereof. The volatile or non-volatile storage device includes but is not limited to: a magnetic or optical disk, an electrically-erasable programmable read only memory (EEPROM), an erasable programmable read-only memory (EPROM), a static random access memory (SRAM), a read-only memory (ROM), a magnetic memory, a flash memory, a programmable read-only memory (PROM).

The present disclosure also provides a terminal. The terminal includes a memory and a processor. The memory stores at least one program code. The at least one program code, when loaded and executed by the processor, causes the processor to perform the method for processing information as described above.

The present disclosure also provides a terminal. The terminal includes a memory and a processor. The memory stores at least one program cod. The at least one program code, when loaded and executed by the processor, causes the processor to perform the method for transmitting data as described above.

The present disclosure also provides a computer-readable storage medium. The computer-readable storage medium stores one or more computer programs. The one or more computer programs, when loaded and run by a processor, cause the processor to perform the method for processing information or the method for transmitting data as described above.

The present disclosure also provides a chip. The chip includes one or more programmable logic circuits and/or one or more program instructions. An electronic device equipped with the chip, when running, is caused to perform the method for processing information or the method for transmitting data as described above.

The present disclosure also provides a computer program product. The computer program product includes one or more computer instructions stored in a computer-readable storage medium. The one or more computer instructions, when read from the computer-readable storage medium and executed by a processor, cause the processor to perform the method for processing information or the method for transmitting data as described above.

Described above are merely exemplary embodiments of the present disclosure and are not intended to limit the present disclosure. Any modifications, equivalent replacements, improvements, and the like, made within the spirit and principles of the present disclosure should fall within the protection scope of the present disclosure.

1. A method for processing information, applicable to a terminal, the method comprising:
resetting or partially resetting medium access control (MAC) during a layer 1/layer 2-triggered mobility (LTM) process.

2. The method according to claim 1, wherein partially resetting the MAC comprises at least one of:
stopping a running timing advance timer (TAT);
canceling a triggered beam failure recovery (BFR), and resetting a beam failure indication counter corresponding to the BFR, wherein the triggered BFR does not comprise a BFR triggered by a first serving cell;
canceling a triggered consistent listen before talk (LBT) failure, and resetting a counter corresponding to the triggered consistent LBT failure, wherein the triggered consistent LBT failure does not comprise a consistent LBT failure triggered by a first serving cell;
retaining data of a hybrid automatic repeat request (HARQ) entity corresponding to a second serving cell in an HARQ buffer;
suspending use of a configured grant (CG) resource associated with a second serving cell, wherein a type of the CG resource comprises a CG type 1 and a CG type 2;
suspending use of a physical uplink control channel (PUCCH) resource associated with a second serving cell;
suspending use of a physical uplink shared channel (PUSCH) resource associated with a second serving cell;
suspending use of a downlink semi-persistent scheduling (DL SPS) resource associated with a second serving cell; or
suspending use of a sounding reference signal (SRS) resource associated with a second serving cell.

3. The method according to claim 2, wherein the TAT does not comprise a timer corresponding to a first timing advance group (TAG);
wherein the first TAG is at least one of:
a TAG associated with a target cell to which the terminal performs cell handover;
a TAG indicated in an LTM handover command; or
a TAG associated with a third serving cell that remains unchanged before and after cell handover.

4. The method according to claim 2, wherein there is one of:
the first serving cell is a serving cell that remains unchanged and is in an active state before and after cell handover;
the first serving cell is indicated by at least one of an upper layer or an LTM handover command; or
the second serving cell comprises at least one of:
all serving cells before cell handover;
a source primary cell or a source primary secondary cell before cell handover;
a serving cell that remains unchanged and is in an active state before and after cell handover;
a serving cell indicated in an LTM handover command;
a serving cell for which a TAT corresponding to an associated TAG has not stopped running;
a serving cell that is a secondary cell before cell handover and is a primary cell after the cell handover; or
a serving cell that is a primary cell before cell handover and is a secondary cell after the cell handover.

5. The method according to claim 2, further comprising:
in a case of partially resetting the MAC, skipping performing at least one of:
canceling a triggered buffer status report (BSR) procedure;
initializing a variable Bj for a logical channel; or
canceling a triggered power headroom report (PHR) procedure.

6. The method according to claim 2, further comprising:
performing resource initialization in a case where the data of the HARQ entity corresponding to the second serving cell is retained in the HARQ buffer;
wherein the resource initialization comprises at least one of:
initializing or reinitializing the CG resource;
initializing or reinitializing the PUCCH resource;
initializing or reinitializing the PUSCH resource;
initializing or reinitializing the SPS resource;
initializing or reinitializing the SRS resource;
initializing or reinitializing the CG resource in a case where first indication information is received; or
initializing or reinitializing the CG resource in a case where a first timer expires, wherein the first timer is a timer started after the terminal successfully accesses a target cell.

7. The method according to claim 6, further comprising:
after expiration of a second timer and/or after receipt of second indication information, performing data transmission over an initialized or reinitialized resource;
wherein the second timer is a timer started after resource initialization;
wherein the method further comprises:
during operation of the second timer and/or before receipt of the second indication information, performing data transmission over a first resource corresponding to an HARQ process;
wherein the first resource meets at least one of the following conditions:
an HARQ buffer corresponding to an HARQ process identification (HPID) associated with the first resource is vacant; or
a size of the first resource matches a size of data cached in an HARQ buffer corresponding to an HPID.

8. The method according to claim 6, wherein:
at least one of the first indication information or second indication information is applicable to all second serving cells; or
at least one of the first indication information or second indication information is applicable to the second serving cell indicated by the at least one of the first indication information or second indication information;
wherein at least one of the first indication information or the second indication information carries a serving cell identifier.

9. The method according to claim 6, wherein:
at least one of the first timer or the second timer is maintained per cell group; or
at least one of the first timer or the second timer is maintained per serving cell.

10. The method according to claim 9, wherein:
in a case where the first timer is maintained per cell group, performing resource initialization for a fourth serving cell within the cell group after the first timer expires; wherein the fourth serving cell is a serving cell configured with the CG resource and with cached data in the HARQ buffer within the cell group; or
in a case where the second timer is maintained per cell group, the terminal located in a third serving cell performing data transmission over an initialized or reinitialized resource after the second timer expires; wherein the third serving cell is a serving cell configured with a transmission resource and with cached data in the HARQ buffer within the cell group.

11. A terminal, comprising:
a memory and a processor;
wherein the memory is configured to store at least one program code, which when executed by the processor, causes the terminal to:
reset or partially reset medium access control (MAC) during a layer 1/layer 2-triggered mobility (LTM) process.

12. The terminal according to claim 11, wherein the at least one program code, which when executed by the processor, further causes the terminal to:
retransmit a radio link control service data unit (RLC SDU) to a target cell.

13. The terminal according to claim 12, wherein the RLC SDU is retransmitted in a case where: the MAC is reset; or the MAC is partially reset, and data in an HARQ buffer is cleared; and/or
wherein the at least one program code, which when executed by the processor, further causes the terminal to:
after successful access to the target cell, retransmit the RLC SDU to the target cell; or
after receipt of indication information from at least one of a lower layer or an upper layer, retransmit the RLC SDU to the target cell.

14. The terminal according to claim 12, wherein the RLC SDU comprises at least one of:
an RLC SDU delivered to a lower layer within a transmission window and with an unacknowledged transmission status; or
an RLC SDU indicated as a negative acknowledgement in a status packet data unit (STATUS PDU).

15. The terminal according to claim 14, wherein the at least one program code, which when executed by the processor, further causes the terminal to:
trigger polling before receipt of the STATUS PDU from a network device;
wherein the polling is triggered under at least one of the following conditions and/or timings:
the terminal successfully accesses the target cell;
the terminal receives signaling for cell handover;
before expiration of a first timer, the terminal does not meet a first condition for triggering the polling, wherein the first timer is a timer started after the terminal successfully accesses the target cell; or
indication information is received from at least one of the lower layer or an upper layer;
wherein the first condition for triggering the polling comprises at least one of the following items:
a number of acknowledged mode data (AMD) protocol data units (PDUs) delivered to the lower layer reaches a first threshold;
a number of bytes in an AMD PDU reaches a second threshold;
a transmission memory and a retransmission memory are vacant;
a transmission window for transmitting data is fully occupied;
a polling retransmission timer expires, and a transmission memory and a retransmission memory are vacant; or
a polling retransmission timer expires, and a transmission window for transmitting data is fully occupied.

16. The terminal according to claim 11, wherein:
indication information for resetting or partially resetting the MAC is carried in an LTM handover command; or
indication information for resetting or partially resetting the MAC is carried in configuration information of a candidate cell/a candidate cell group.

17. The terminal according to claim 11, wherein the at least one program code, which when executed by the processor, further causes the terminal to:
receive first signaling from a network device;
wherein the first signaling is used to instruct to reset or partially reset the MAC during the LTM process.

18. The terminal according to claim 17, wherein the at least one program code, which when executed by the processor, further causes the terminal to:
during the LTM process, retain data of a hybrid automatic repeat request (HARQ) entity corresponding to a second serving cell in an HARQ buffer based on the first signaling;
wherein the at least one program code, which when executed by the processor, further causes the terminal to:
after access to the second serving cell, suspend initialization or reinitialization of a second configured grant (CG) resource corresponding to the second serving cell; or
after access to the second serving cell, perform initialization or reinitialization of a second configured grant (CG) resource corresponding to the second serving cell, and suspend use of a third CG resource acquired by performing the initialization or the reinitialization.

19. The terminal according to claim 17, wherein the at least one program code, which when executed by the processor, further causes the terminal to:
during the LTM process, retain data of a hybrid automatic repeat request (HARQ) entity corresponding to a second serving cell in an HARQ buffer based on the first signaling, and suspend use of a second configured grant (CG) resource corresponding to the second serving cell;
wherein the at least one program code, which when executed by the processor, further causes the terminal to:
after access to the second serving cell, suspend initialization or reinitialization of the second CG resource corresponding to the second serving cell; or
after access to the second serving cell, acquire a third CG resource by performing reinitialization of the second CG resource corresponding to the second serving cell, and retransmit data cached in the HARQ buffer using the third CG resource.

20. A terminal, comprising:
a memory and a processor;
wherein the memory is configured to store at least one program code, which when executed by the processor, causes the terminal to:
transmit uplink data over at least one of a medium access control (MAC) layer or a radio link control (RLC) layer.
